(19) United States
(12) Patent Application Publication
(10) Pub. No.: US 2017/0282872 A1
(43) Pub. Date: Oct. 5, 2017

(54) BRAKING METHOD IN THE CASE OF EMERGENCY OR FULL BRAKING

(71) Applicant: Continental Teves AG & Co. oHG, Frankfurt (DE)

(72) Inventor: Paul Linhoff, Neu-Anspach (DE)

(73) Assignee: Continental Teves AG & Co. oHG, Frankfurt (DE)

(21) Appl. No.: 15/625,713

(22) Filed: Jun. 16, 2017

Related U.S. Application Data
(63) Continuation of application No. PCT/EP2015/076482, filed on Nov. 12, 2015.

(30) Foreign Application Priority Data
Dec. 19, 2014 (DE) 10 2014 226 704.8

(51) Int. Cl. B60T 8/1766; B60T 8/26; B60T 13/74

(52) U.S. Cl. CPC B60T 8/1766; B60T 13/746; B60T 8/26; B60T 2260/09

(57) ABSTRACT

A vehicle's electronic brake system is controlled to prevent rear-to-front body sway. A clamping force is applied to the rear and front axle brakes such that the clamping force is built up in the brakes of the rear axle before the clamping force is built up in the brakes of the front axle such that the distance of a rear part of the vehicle body relative to the roadway is substantially constant at the beginning of braking.

This application claims the benefit of PCT Application PCT/EP2015/076482, filed Nov. 12, 2015, which claims priority to German Application DE 10 2014 226 704.8, filed Dec. 19, 2014. The disclosures of the above applications are incorporated herein by reference

The invention relates to a method for controlling an electronic brake system according to the preamble of claim 1, and also a device of an electronic brake system.

Hydraulic brake systems are primarily used presently in motor vehicles. Known hydraulic vehicle brake systems usually comprise wheel brakes (for example, hydraulically actuated disk brakes), an electrohydraulic brake slip driving stability control unit (HECU), and a brake actuating unit, for example, having a vacuum brake booster. In electromechanical brakes, which are also already known per se, in comparison to conventional hydraulic brake systems, high brake pressures can be generated in a shorter time than in the abovementioned brake systems.

A combined service brake system for motor vehicles having electromechanically actuable wheel brakes on the wheels of the rear axle and hydraulically actuable wheel brakes on the wheels of the front axle is known from WO 2007/014952 A1. Pressure medium can be applied to the hydraulically actuable wheel brakes with the aid of a brake-pedal-actuated vacuum brake booster having downstream, single-circuit master brake cylinder.

As a result of the relief of the rear axle due to the longer brake line to the rear axle in this brake system, a time delay of the rear axle occurs in comparison to the front axle. In the case of an assumed weight distribution of 50% of the weight force of the vehicle on each of the rear and front axles, in the case of full braking, not only the weight force of the vehicle perpendicularly to the roadway acts, but also the deceleration force in the travel direction. Due to the brake action of the front axle, which occurs before the rear axle, the vehicle center of gravity is displaced perpendicularly toward the roadway and simultaneously in the travel direction. Because the front axle is braked before the rear axle with respect to time, the principle of levers acts and the front vehicle part dives, wherein the rear vehicle part lifts up. This deflection results in a temporary dynamic shift of the vehicle center of gravity and can result, for example, in a change of the weight distribution of approximately 70% on the front axle and 30% on the rear axle.

To ensure the driving stability, an electronic brake force distribution controller (EBC), which generally operates according to the select-low principle, prevents locking of the wheels. In this case, the brake pressure on the rear axle is reduced in the electronic brake system, typically up to a velocity of 80 km/h, to prevent locking of the wheels. Rebounding of the rear axle results therefrom, whereby it is relieved and therefore the contact pressure sinks.

It is to be expected that in the future vehicle brake systems which are suitable for autonomous vehicles will also be used. These brake systems are fundamentally externally-controllable systems. This means that a brake request is requested via an electrical control signal and has to be implemented by the system without action by the driver. For this purpose, a sufficiently high level of availability of the brake system or the externally-controllable brake function also has to be ensured. This can be achieved in general by providing redundancies.

It is therefore the object of the invention to provide a method for controlling an electronic brake system, in which in particular in the case of emergency or full braking, the braking distance is thus shortened and the braking is perceived as more pleasant by the vehicle occupants.

This object is achieved by the method specified in claim 1.

### SUMMARY

The method according to the invention for controlling an electronic brake system comprises a rapidly responding brake on the rear axle combined with a slowly responding brake on the front axle. In this method, during a brake actuation, in particular emergency or full braking, a clamping force and a brake pressure are built up independently of one another on the rear axle and the front axle, respectively, in the electronic brake system, wherein the setting of the clamping force of the respective brake of the rear axle or front axle is performed in such a way that in the brake or brakes of the rear axle, the clamping force is built up before the brake of the front axle with respect to time and the dimensioning of the clamping force is performed in such a manner that during braking, the distance of the rear part of the vehicle body to the roadway does not increase at least at the beginning of the braking.

In this case, a rapidly responding brake is to be understood by way of example as an electromechanical brake or an electrohydraulic brake and a slowly responding brake as a hydraulic brake. Furthermore, the clamping force is identified with Z in the method.

The brake distribution is performed such that the clamping force or the brake pressure, which are built up independently of one another, of the brake of the rear axle and the brake of the front axle, respectively, have the result that lowering and displacement of the motor vehicle center of gravity takes place in an approximately uniform weight distribution of the motor vehicle on the rear and front axles. In the case of full braking, the rear vehicle part firstly dives and upon engagement of the brake of the front axle, the vehicle sinks at both axles uniformly toward the ground. The principle of levers is thus counteracted. The only slight change of the weight forces on the axles has an advantageous effect on the braking distance. Due to the higher weight on the rear axle in comparison to the prior art, or due to the higher contact pressure, the existing brake force is utilized better and therefore also the tire adhesion on the road is increased. A further advantage results for the vehicle occupants, who perceive emergency or full braking as more pleasant, because the negative dynamic effects are attenuated. As a result of the shortened braking distance, the pedestrian protection is additionally also increased.

According to a further preferred embodiment of the invention, the method is only carried out in the event of an autonomously triggered brake actuation of the electronic brake system.

In comparison to full braking actuated by the vehicle driver, the autonomous system reacts earlier in case of danger. In conjunction with the shortened braking distance, this combination is particularly advantageous.

According to a further preferred embodiment of the invention, an axle-selective or wheel-selective brake actuation is carried out in the method, wherein the locking sequence is controlled via a slip control system and the braking procedure is still ensured.

According to a further preferred embodiment of the invention, the distance of the rear part of the vehicle body in relation to the roadway is additionally prevented from increasing as late as possible or not at all by means of a shock absorber controller or chassis controller.

Preferably, a soft damping mode is set on the shock absorbers of the rear axle in the event of brake actuation and the shock absorbers of the rear axle are fixed in the event of action of the brake of the front axle.

By setting a soft damping mode on the rear axle in the event of brake actuation, the diving of the rear vehicle part is facilitated. In the following step, upon action of the brake pressure on the front axle, the shock absorber of the rear axle is fixed such that the vehicle level can no longer change.

According to a further preferred embodiment of the invention, the distance of the rear part of the vehicle body in relation to the roadway is additionally prevented from increasing until at least later or not at all by means of a weight force increase on the rear axle.

The invention additionally relates to a device of an electronic brake system, comprising an electromechanical brake or an electrohydraulic combination brake on the rear axle combined with a hydraulic brake on the front axle.

Further preferred embodiments result from the dependent claims and the following description of an exemplary embodiment on the basis of figures.

### BRIEF DESCRIPTION OF THE FIGURES

In the figures:

FIG. 1 shows a motor vehicle having a weight distribution which occurs in the event of braking of the front axle according to the prior art,

FIG. 2 shows a schematic illustration of a motor vehicle during braking with sinking of the vehicle center of gravity,

FIG. 3 shows the vehicle corresponding to FIG. 1 with a weight distribution which occurs in the event of braking of the rear axle, and

FIG. 4 shows a force-time diagram, in which the clamping force Z of the rear and front axles is plotted over the time T.

### DETAILED DESCRIPTION

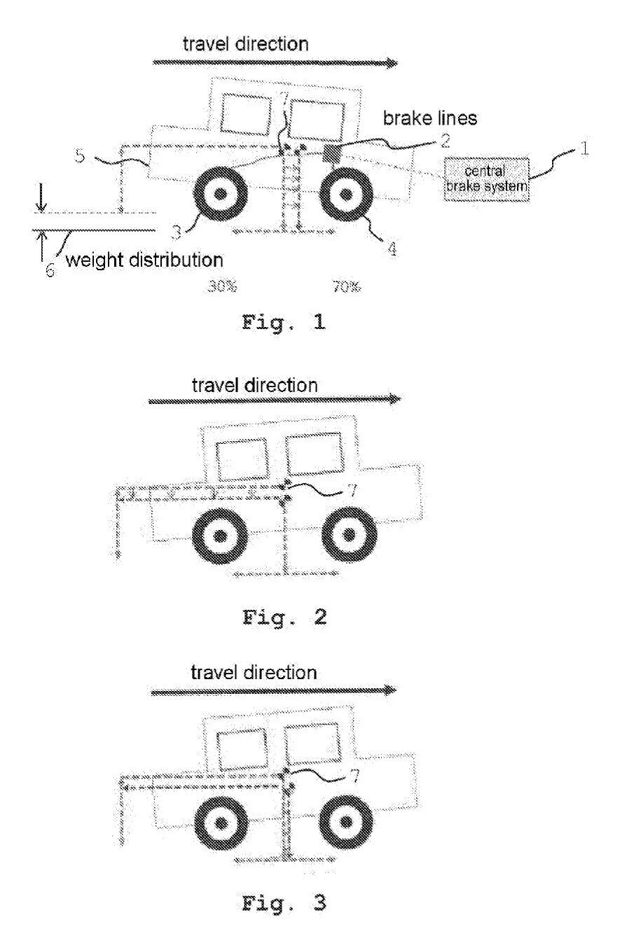

FIG. 1 illustrates the prior art. The figure shows the displacement of the vehicle center of gravity 7 in the travel direction during braking. The vehicle weight is distributed in this case, for example, with 70% on the front axle 4 and 30% on the rear axle 3. This occurs in that in case of braking, the brake of the front axle 4 acts before the brake of the rear axle 3 with respect to time.

FIG. 2 shows the sinking of the vehicle center of gravity 7 during braking, in the case of which the brake system starts first on the rear axle 3. Due to the prior action of the brake of the rear axle 3, the rear vehicle part 5 dives and the vehicle center of gravity is displaced perpendicularly in relation to the roadway 6. This is assisted by soft rear axle damping or a chronologically restricted mass increase on the rear axle.

In the further procedure, as shown in FIG. 3, the more uniform weight distribution on front and rear axles according to the invention takes place. During braking, in which the brake system 2 on the front axle 4 builds up brake pressure after the rear axle 3 with respect to time, the vehicle center of gravity 7 is displaced less intensely in the travel direction than shown in FIG. 1. This is because the vehicle center of gravity 7 has already sunk perpendicularly in relation to the roadway 6.

The braking distance is thus significantly shortened in relation to the prior art by means of the displacement of the vehicle center of gravity 7. A higher weight on the rear axle thus results, or the contact pressure is increased, whereby the existing brake force can be utilized better and therefore the tire adhesion on the roadway 6 is also increased.

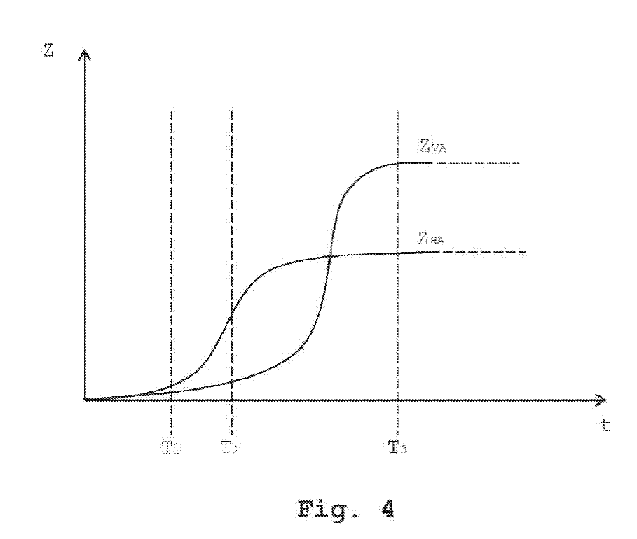

In the force-time diagram shown in FIG. 4, the clamping force Z is plotted over the time axis t. In this case, the different curves of the clamping force Z of the respective axle are shown with Z_{HA} for the rear axle and with Z_{VA} for the front axle. The time T₁ shows a time in the first time curve of the clamping forces in the case of emergency or full braking according to the method according to the invention. In this case, at time T₁, the clamping force of the rear axle Z_{HA} is greater than the clamping force of the front axle Z_{VA}. At time T₂, the slip control system of the electronic brake system starts and controls the locking behavior of the wheels. In the further time curve of the emergency or full braking at T₃, the clamping force of the front axle Z_{VA} is then greater than the clamping force of the rear axle Z_{HA} to ensure the driving stability.

1. A method for controlling a vehicle's electronic brake system in which a rapidly responding brake on the rear axle of the vehicle is combined with a slowly responding brake on the front axle and in which during a brake actuation a clamping force is built up independently on the rear axle and the front axle, the method comprising:
providing a clamping force to the rear and front axle brakes such that the clamping force is built up in the brakes of the rear axle before the clamping force is built up in the brakes of the front axle such that the distance of a rear part of the vehicle body relative to the roadway is substantially constant at the beginning of braking.

2. The method of claim 1, wherein an electromechanical brake on the rear axle is combined with a hydraulic brake on the front axle.

3. The method of claim 1, wherein a wheel-selective brake control is applied wherein a locking sequence is determined with a brake slip control system.

4. The method as of claim 1, wherein the distance of the rear part of the vehicle body relative to the roadway is delayed using a shock absorber.

5. The method of claim 4, wherein a soft damping mode is provided by shock absorbers for the rear axle and in the event of action of the brake of the front axle, the shock absorbers of the rear axle are set in a fixed mode.

7. The method of claim 1, wherein the distance of the rear part of the vehicle body relative the roadway is additionally prevented from increasing using a weight force increase on the rear axle.
